(19) United States
(12) Patent Application Publication
(10) Pub. No.: US 2016/0046003 A1
(43) Pub. Date: Feb. 18, 2016

(54) Clamping Device Preventing Disengagement of an Adjusting Screw

(71) Applicant: Ming Chieh Wu, Taichung City (TW)

(72) Inventor: Ming Chieh Wu, Taichung City (TW)

(21) Appl. No.: 14/459,358

(22) Filed: Aug. 14, 2014

(51) Int. Cl. B25B 7/12; B25B 7/02

(52) U.S. Cl. CPC B25B 7/123; B25B 7/02

(57) ABSTRACT

A clamping device includes first and second clamping members. Each of the first and second clamping members has a handle and a jaw. The handle of the first clamping member includes an inner threaded portion extending along a longitudinal axis and an adjusting screw threadedly engaged with the inner threaded portion. The adjusting screw includes a first end having a disengagement preventing portion located in a sliding section between two ends of the handle of the first clamping member. The adjusting screw further includes a second end located outside of the handle of the first clamping member. The disengagement preventing portion of the handle of the first clamping member has a maximal height perpendicular to the longitudinal axis not smaller than a minimal inner diameter of the inner threaded portion perpendicular to the longitudinal axis. The disengagement preventing portion prevents the adjusting screw from disengaging from the handle.

### BACKGROUND OF THE INVENTION

The present invention relates to a clamping device and, more particularly, to a clamping device preventing disengagement of an adjusting screw.

Taiwan Patent Publication No. 239357 discloses an improved general purpose pliers including a long, wide protrusion at a jaw opening thereof. The protrusion includes two rows of teeth, wherein one of the row of teeth inclines to a side, and the other row of teeth inclines to the other side, such that when the jaw opening with the two rows of teeth inclining in different directions is used to clamp a cylindrical metal tube, a better, uneasy-to-loosen clamping effect can be provided. Furthermore, a sleeve is provided on an end of a handle and includes a screw hole, and a screw is threadedly engaged in the screw hole. The sleeve provides a reinforcing effect to prevent deformation of the handle while allowing rotation of the screw in the sleeve.

The screw can be rotated to adjust the tightness of the jaw opening of the general purpose pliers. However, the screw cannot be seen during the tightness adjustment. Namely, a user cannot know the length of a section of the screw in the sleeve. The screw could disengage from the general purpose pliers if the user keeps loosening the screw, and the user must reattach it back to the general purpose pliers, which is troublesome.

Thus, a need exists for a clamping device preventing disengagement of an adjusting screw to avoid the drawbacks of the conventional structure.

### BRIEF SUMMARY OF THE INVENTION

A clamping device according to the present invention includes a first clamping member and a second clamping member. The first clamping member includes a first handle and a first jaw. The first handle includes a connecting end and a holding end. The holding end includes an inner threaded portion extending along a longitudinal axis. The inner threaded portion extends from the holding end towards the connecting end of the first handle. The inner threaded portion has a minimal inner diameter perpendicular to the longitudinal axis. The first handle further includes a sliding section formed between the connecting end and the holding end of the first handle. The sliding section is located adjacent to the holding section of the handle. The first handle includes an adjusting screw threadedly engaged with the inner threaded portion. The adjusting screw includes a first end having a disengagement preventing portion. The disengagement preventing portion is located in the sliding section. The adjusting screw further includes a second end located outside of the first handle. The disengagement preventing portion of the first handle has a maximal height perpendicular to the longitudinal axis. The maximal height is not smaller than the minimal inner diameter. The second end of the adjusting screw moves towards or away from the connecting end of the first handle along the longitudinal axis when the adjusting screw rotates about the longitudinal axis. The first jaw includes a front end and a rear end. The rear end of the first jaw is connected to the connecting end of the first handle. The first jaw further includes a clamping portion between the front end and the rear end of the first jaw.

The second clamping member is coupled to the first clamping member. The second clamping member includes a second handle and a second jaw. The second handle includes a connecting end and a holding end. The second jaw includes a front end and a rear end. The rear end of the second jaw includes an inner side pivotably connected to the connecting end of the first handle. The rear end of the second jaw further includes an outer side pivotably connected to the connecting end of the second handle. The second jaw further includes a clamping portion between the front end and the rear end of the second jaw. The clamping portions of the first and second jaws face each other. The second clamping member further includes a pressing member and an elastic element. The pressing member includes a first end pivotably connected between the connecting end and the holding end of the second handle. The pressing member further includes a second end slideably received in the sliding section of the first handle. The second end of the pressing member abuts the first end of the adjusting screw. The elastic element includes a first end attached to the rear end of second jaw and a second end attached between the connecting end and the holding end of the first handle. The elastic element biases the second jaw and the first handle towards each other.

The maximal height can be not smaller than the maximal inner diameter of the inner threaded portion.

In an embodiment, the disengagement preventing portion includes a disengagement preventing ring mounted around the disengagement preventing portion and surrounding the longitudinal axis. The disengagement preventing ring is a C-shaped retainer ring.

In another embodiment, the disengagement preventing portion includes a disengagement preventing pin. The disengagement preventing pin extends perpendicularly to the longitudinal axis C and extends through the disengagement preventing portion 216a. The disengagement preventing pin is a pin.

In a further embodiment, the disengagement preventing portion includes a disengagement preventing protrusion. The disengagement preventing protrusion protrudes from the disengagement preventing portion in a radial direction perpendicular to the longitudinal axis. The disengagement preventing protrusion is integral with the disengagement preventing portion and is formed by deforming the disengagement preventing portion by striking.

The front end and the rear end of the first jaw and the holding end of the first handle can substantially be located on the same line. The front end and the rear end of the second jaw and the holding end of the second handle can substantially located on the same line.

The second clamping member can further include a releasing member pivotably mounted to the second handle. The releasing member is located between the pressing member and the holding end of the second handle. The elastic element can be a tension spring.

Other objectives, advantages, and novel features of the present invention will become clearer in light of the following detailed description described in connection with the accompanying drawings.

### DESCRIPTION OF THE DRAWINGS

FIG. 1 is a perspective view of a clamping device of a first embodiment according to the present invention.

FIG. 2 is a partial, exploded, perspective view of the clamping device of FIG. 1.

FIG. 3 is a partial, top view of the clamping device of FIG. 1, with a portion of the clamping device cross sectioned.

FIG. 4 is a top view of the clamping device of FIG. 1, illustrating use of the clamping device for clamping an object.

FIG. 5 is a top view of the clamping device of FIG. 4, with the object clamped by the clamping device.

FIG. 6 is a partial, exploded, perspective view of a clamping device of a second embodiment according to the present invention.

FIG. 7 is a partial, top view of the clamping device of the second embodiment according to the present invention.

FIG. 8 is a partial, top view of a clamping device of a third embodiment according to the present invention.

### DETAILED DESCRIPTION OF THE INVENTION

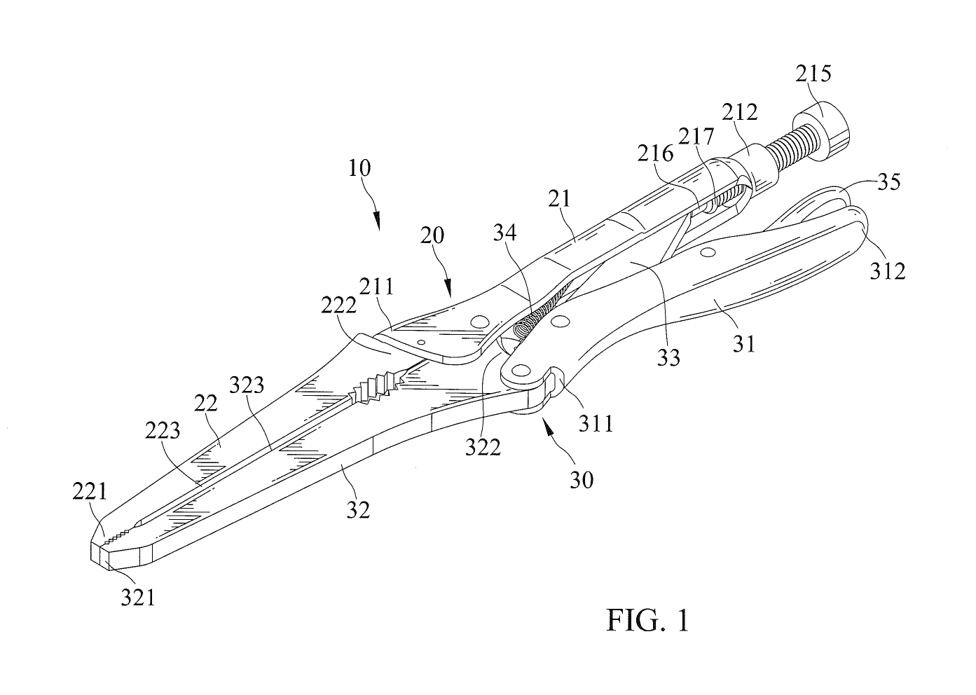

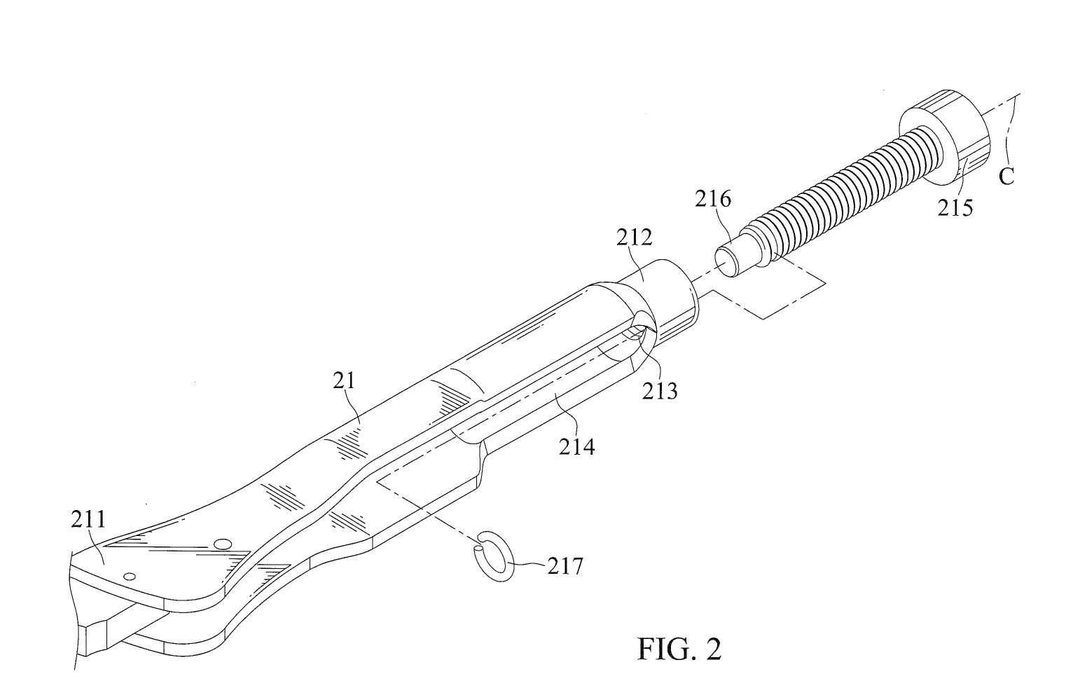

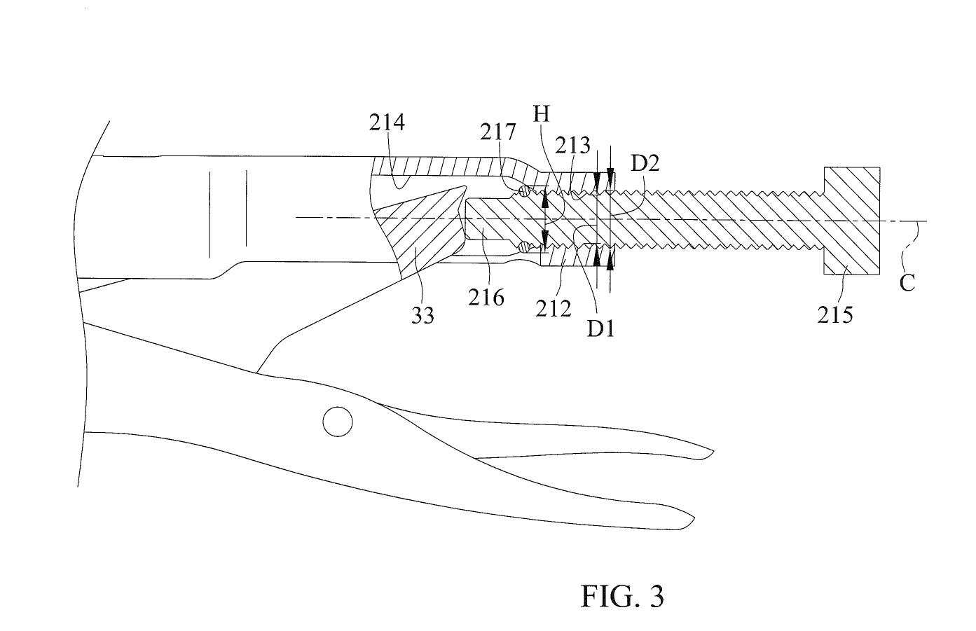

With reference to FIGS. 1-5, a clamping device 10 of a first embodiment according to the present invention includes a first clamping member 20 and a second clamping member 30.

The first clamping member 20 includes a first handle 21 and a first jaw 22. The first handle 21 includes a connecting end 211 and a holding end 212 opposite to the connecting end 211. The holding end 212 includes an inner threaded portion 213 extending along a longitudinal axis C. The inner threaded portion 213 extends from the holding end 212 towards the connecting end 211 of the first handle 21. The inner threaded portion 213 has a minimal inner diameter D1 perpendicular to the longitudinal axis C. The inner threaded portion 213 further has a maximal inner diameter D2. The first handle 21 further includes a sliding section 214 formed between the connecting end 211 and the holding end 212. The sliding section 214 is located adjacent to the holding section 212 of the handle 21.

The first handle 21 includes an adjusting screw 215 threadedly engaged with the inner threaded portion 213. The adjusting screw 215 includes a first end having a disengagement preventing portion 216. The disengagement preventing portion 216 is located in the sliding section 214. The adjusting screw 215 further includes a second end located outside of the first handle 21. The second end of the adjusting screw 215 moves towards or away from the connecting end 211 of the first handle 211 along the longitudinal axis C when the adjusting screw 215 rotates about the longitudinal axis C.

The disengagement preventing portion 216 includes a disengagement preventing ring 217 mounted around the disengagement preventing portion 216 and surrounding the longitudinal axis C. In this embodiment, the longitudinal axis C is coincident to a central axis of the disengagement preventing ring 217 mounted around the disengagement preventing portion 216. The disengagement preventing portion 216 of the first handle 21 has a maximal height H perpendicular to the longitudinal axis C. The maximal height H is not smaller than the minimal inner diameter D1. In this embodiment, the maximal height H is not smaller than the maximal inner diameter D2, and the disengagement preventing ring 217 is a C-shaped retainer ring.

The first jaw 22 includes a front end 221 and a rear end 222 opposite to the front end 221. The rear end 222 of the first jaw 22 is connected to the connecting end 211 of the first handle 21. The first jaw 22 further includes a clamping portion 223 between the front end 221 and the rear end 222 of the first jaw 22. The front end 221 and the rear end 222 of the first jaw 22 and the holding end 212 of the first handle 21 are substantially located on the same line.

The second clamping member 30 is coupled to the first clamping member 20. The second clamping member 30 includes a second handle 31 and a second jaw 32. The second handle 31 includes a connecting end 311 and a holding end 312 opposite to the connecting end 311. The second jaw 32 includes a front end 321 and a rear end 322 opposite to the front end 321. The rear end 322 of the second jaw 32 includes an inner side pivotably connected to the connecting end 211 of the first handle 21. The rear end 322 of the second jaw 32 further includes an outer side pivotably connected to the connecting end 311 of the second handle 31.

The second jaw 32 further includes a clamping portion 323 between the front end 321 and the rear end 322. The clamping portions 223 and 323 of the first and second jaws 22 and 32 face each other. The front end 321 and the rear end 322 of the second jaw 32 and the holding end 312 of the second handle 31 are substantially located on the same line when the clamping device 10 is in a state shown in FIG. 1.

The second clamping member 30 further includes a pressing member 33 and an elastic element 34. The pressing member 33 includes a first end pivotably connected between the connecting end 311 and the holding end 312 of the second handle 31. The pressing member 33 further includes a second end slideably received in the sliding section 214 of the first handle 21. The second end of the pressing member 33 abuts the first end of the adjusting screw 215. Thus, the pressing member 33 can move jointly with the adjusting screw 215 relative to the first handle 21 when the adjusting screw 215 rotates. The elastic element 34 including a first end attached to the rear end 322 of second jaw 32 and a second end attached between the connecting end 211 and the holding end 212 of the first handle 21. The elastic element 34 biases the second jaw 32 and the first handle 21 towards each other. In this embodiment, the elastic element 34 is a tension spring.

The second clamping member 30 further includes a releasing member 35 pivotably mounted to the second handle 31. The releasing member 35 is located between the pressing member 33 and the holding end 312 of the second handle 31.

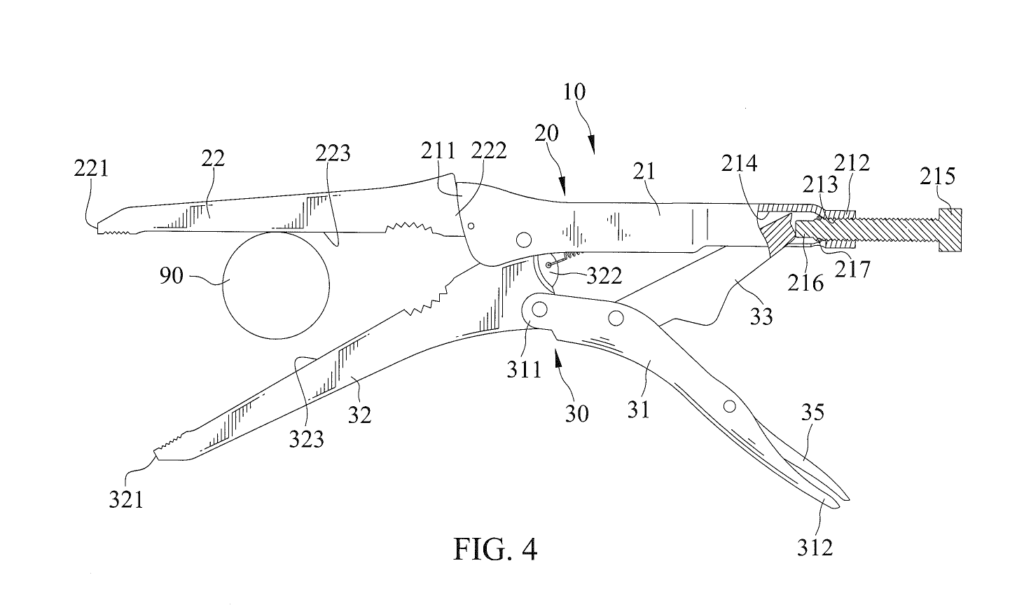

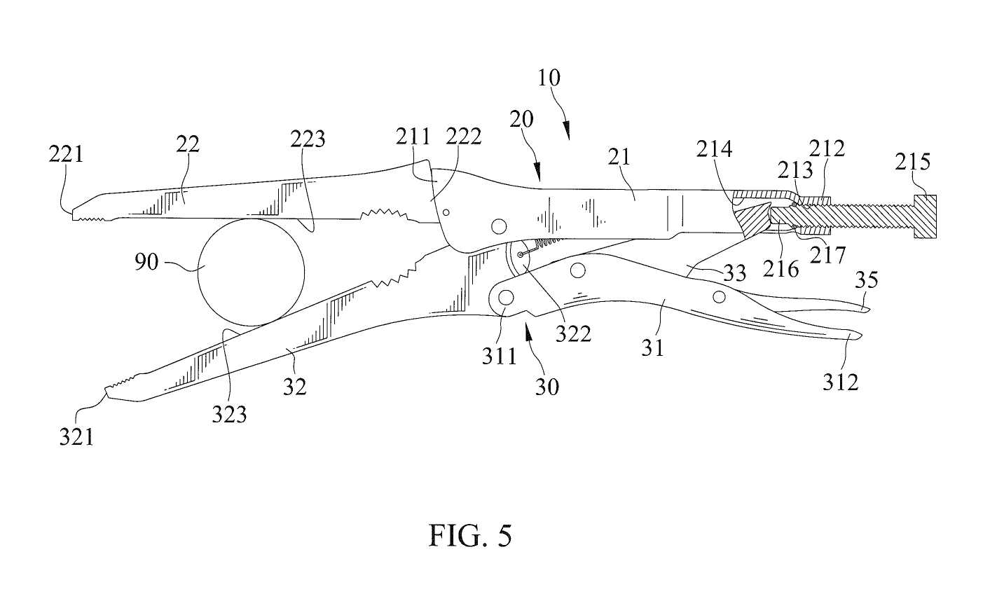

FIGS. 4 and 5 illustrate use of the clamping device 10 of the first embodiment according to the present invention. In use of the clamping device 10, a user can clamp an object 90 by the clamping portion 223 of the first jaw 22 and the clamping portion 323 of the second jaw 32. The clamping portion 223 of the first jaw 22 and the clamping portion 323 of the second jaw 32 move towards each other when the adjusting screw 215 is rotated and moved towards the connecting end 211 of the first handle 21. On the other hand, the clamping portion 223 of the first jaw 22 and the clamping portion 323 of the second jaw 32 move away from each other when the adjusting screw 215 is rotated and moved away from the connecting end 211 of the first handle 21.

The adjusting screw 215 cannot be disengaged from the first handle 21 by the provision of the disengagement preventing ring 217 mounted around the disengagement preventing portion 216, avoiding disengagement of the adjusting screw 215 resulting from excessive rotation of the adjusting screw 215 in a loosening direction away from the holding end 212 of the first handle 21. Furthermore, the disengagement preventing ring 27 is mounted around the disengagement preventing portion 216 after the adjusting screw 215 has threadedly engaged with the first handle 21. Thus, only an easy operation on the clamping device 10 is sufficient to achieve the disengagement preventing effect for the adjusting screw 215.

If the user intends to release the object 90, the user can press the releasing member 35 to push the second clamping member 30 from a clamping position to a releasing position.

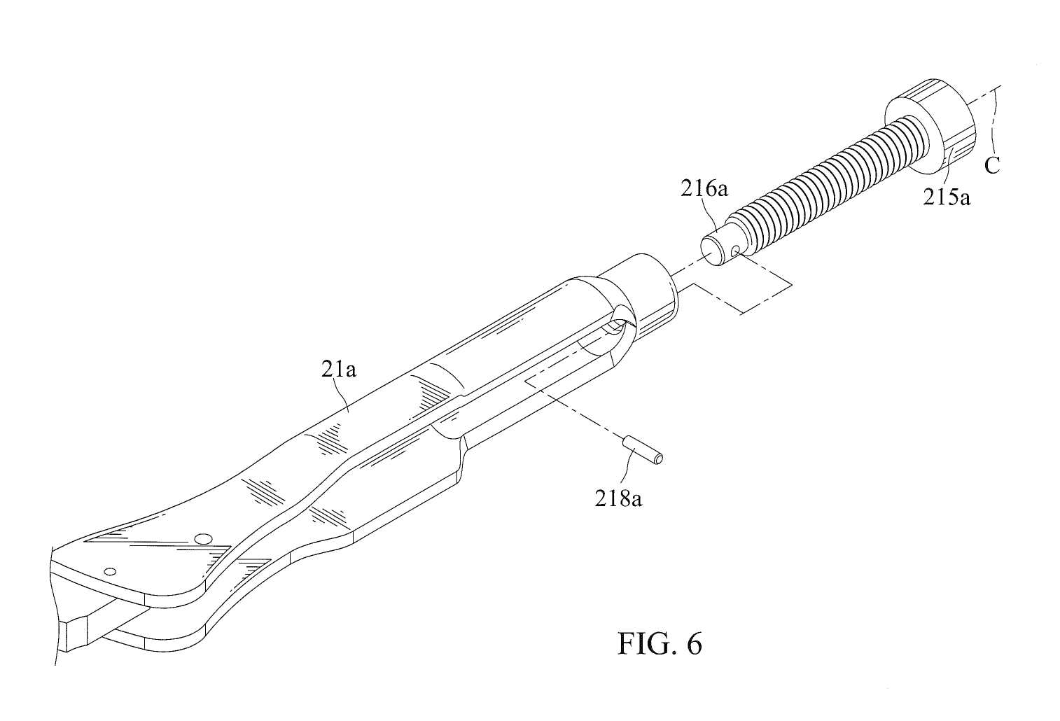

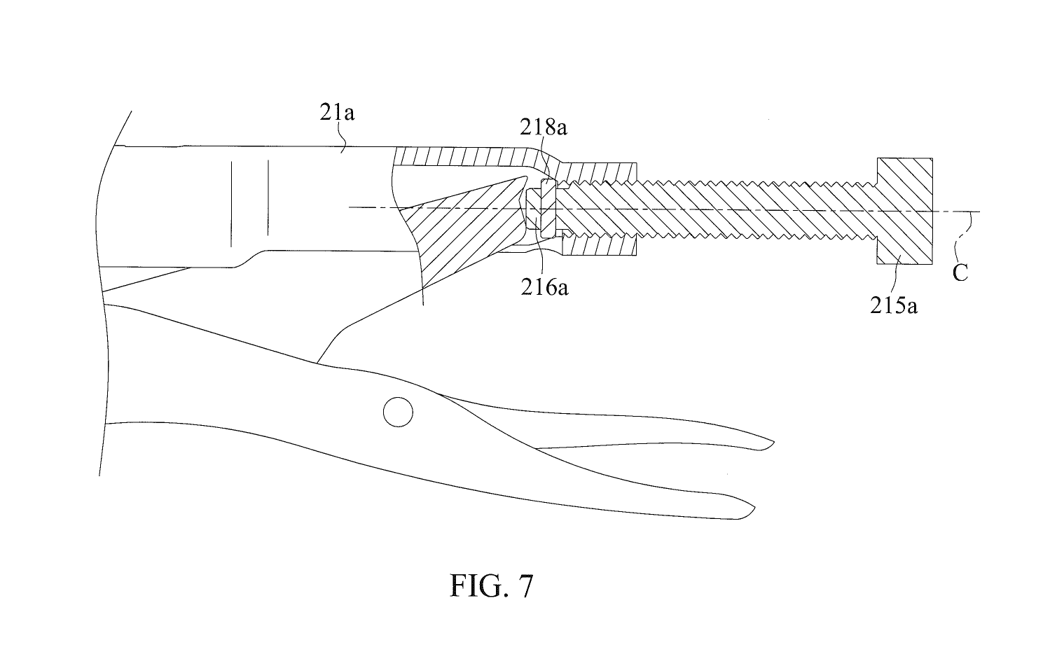

FIGS. 6 and 7 show a portion of a clamping device of a second embodiment according to the present invention. The second embodiment is substantially the same as the first embodiment except that the disengagement preventing portion 216a includes a disengagement preventing pin 218a. The disengagement preventing pin 218a extends perpendicularly to the longitudinal axis C and extends through the disengagement preventing portion 216a. In this embodiment, the disengagement preventing pin 218a is a cylindrical pin. The disengagement preventing pin 218a is inserted through the adjusting screw 215a after the adjusting screw 215a has threadedly engaged with the first handle 21a. Thus, only an easy operation is sufficient to achieve the disengagement preventing effect for the adjusting screw 215a.

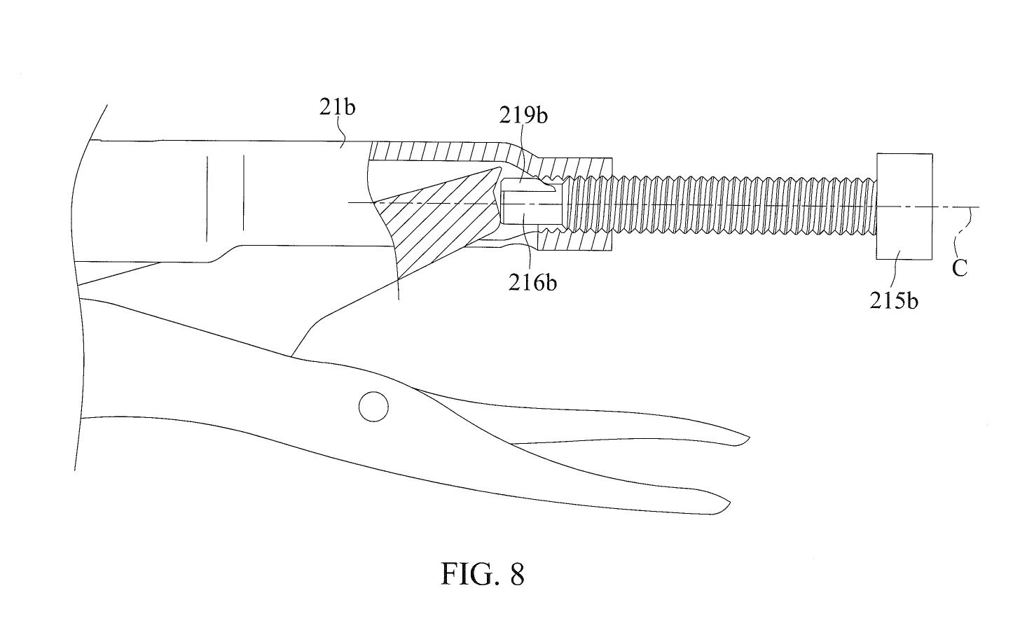

FIG. 8 shows a portion of a clamping device of a third embodiment according to the present invention. The third embodiment is substantially the same as the first embodiment except that the disengagement preventing portion 216b includes a disengagement preventing protrusion 219b. The disengagement preventing protrusion 219b protrudes from the disengagement preventing portion 216b in a radial direction perpendicular to the longitudinal axis C.

The disengagement preventing protrusion 219b is integral with the disengagement preventing portion 216b and is formed by deforming the disengagement preventing portion 216b by striking after the adjusting screw 215b has threadedly engaged with the first handle 21b. Thus, only an easy operation is sufficient to achieve the disengagement preventing effect for the adjusting screw 215b.

Conclusively, disengagement of the adjusting screw 215, 215a, 215b from the first handle 21, 21a, 21b of the clamping device 10 resulting from excessive rotation of the adjusting screw 215, 215a, 215b in the loosening direction can effectively be avoided by the disengagement preventing portion 216, 216a, 216b, which is convenient to use.

Although preferred embodiments of the present invention have been illustrated and described, they should not be construed to restrict the scope of the present invention. Therefore, modifications to numerical values or substitution of equivalent elements thereof or equivalent changes and modifications based on the accompanying claims of the present invention still fall within the scope covered by the present invention.

1. A clamping device comprising:
a first clamping member including a first handle and a first jaw, with the first handle including a connecting end and a holding end, with the holding end including an inner threaded portion extending along a longitudinal axis, with the inner threaded portion extending from the holding end towards the connecting end of the first handle, with the inner threaded portion having a minimal inner diameter perpendicular to the longitudinal axis, with the first handle further including a sliding section formed between the connecting end and the holding end of the first handle, with the sliding section located adjacent to the holding section of the handle, with the first handle including an adjusting screw threadedly engaged with the inner threaded portion, with the adjusting screw including a first end having a disengagement preventing portion, with the disengagement preventing portion located in the sliding section, with the adjusting screw further including a second end located outside of the first handle, with the disengagement preventing portion of the first handle having a maximal height perpendicular to the longitudinal axis, with the maximal height not smaller than the minimal inner diameter, with the second end of the adjusting screw moving towards or away from the connecting end of the first handle along the longitudinal axis when the adjusting screw rotates about the longitudinal axis, with the first jaw including a front end and a rear end, with the rear end of the first jaw connected to the connecting end of the first handle, and with the first jaw further including a clamping portion between the front end and the rear end of the first jaw; and
a second clamping member coupled to the first clamping member, with the second clamping member including a second handle and a second jaw, with the second handle including a connecting end and a holding end, with the second jaw including a front end and a rear end, with the rear end of the second jaw including an inner side pivotably connected to the connecting end of the first handle, with the rear end of the second jaw further including an outer side pivotably connected to the connecting end of the second handle, with the second jaw further including a clamping portion between the front end and the rear end of the second jaw, with the clamping portions of the first and second jaws facing each other, with the second clamping member further including a pressing member and an elastic element, with the pressing member including a first end pivotably connected between the connecting end and the holding end of the second handle, with the pressing member further including a second end slideably received in the sliding section of the first handle, with the second end of the pressing member abutting the first end of the adjusting screw, with the elastic element including a first end attached to the rear end of second jaw and a second end attached between the connecting end and the holding end of the first handle, and with the elastic element biasing the second jaw and the first handle towards each other.

2. The clamping device as claimed in claim 1, with the inner threaded portion having a maximal inner diameter, and with the maximal height not smaller than the maximal inner diameter.

3. The clamping device as claimed in claim 2, with the disengagement preventing portion including a disengagement preventing ring mounted around the disengagement preventing portion and surrounding the longitudinal axis.

4. The clamping device as claimed in claim 3, wherein the disengagement preventing ring is a C-shaped retainer ring.

5. The clamping device as claimed in claim 2, with the disengagement preventing portion including a disengagement preventing pin, with the disengagement preventing pin extending perpendicularly to the longitudinal axis and extending through the disengagement preventing portion.

6. The clamping device as claimed in claim 5, wherein the disengagement preventing pin is a pin.

7. The clamping device as claimed in claim 2, with the disengagement preventing portion including a disengagement preventing protrusion, with the disengagement preventing protrusion protruding from the disengagement preventing portion in a radial direction perpendicular to the longitudinal axis.

8. The clamping device as claimed in claim 7, wherein the disengagement preventing protrusion is integral with the disengagement preventing portion and is formed by deforming the disengagement preventing portion by striking.

9. The clamping device as claimed in claim 2, with the front end and the rear end of the first jaw and the holding end of the first handle substantially located on a same first line, and with the front end and the rear end of the second jaw and the holding end of the second handle substantially located on a same second line.

10. The clamping device as claimed in claim 9, with the second clamping member further including a releasing member pivotably mounted to the second handle, with the releasing member located between the pressing member and the holding end of the second handle, and with the elastic element being a tension spring.
